(19) United States
(12) Patent Application Publication
(10) Pub. No.: US 2006/0150512 A1
(43) Pub. Date: Jul. 13, 2006

(54) Emergency release assembly and sliding door incorporating the same

(75) Inventors: Michael Heithe, Duarte, CA (US); Rory Riley, Orange, CA (US); Lawrence F. Whipple, Fontana, CA (US)

Correspondence Address: MARTIN & HENSON, P.C., 9250 W 5TH AVENUE, SUITE 200, LAKEWOOD, CO, 80226, US

(73) Assignee: Adams Rite Manufacturing Co.

(21) Appl. No.: 10/433,974

(22) PCT Filed: Mar. 3, 2003
(86) PCT No.: PCT/US03/06389

§ 371 Date: Feb. 3, 2006

(51) Int. Cl. E05B 65/10

(52) U.S. Cl. 49/141

(57) ABSTRACT

An emergency release assembly for a door includes a latch mechanism to retain the door in a normally closed position yet releases to let the door move to an emergency open position. A release mechanism triggers the latch mechanism. The release mechanism has a reciprocating member that operates the latch mechanism. A push bar moves from an extended position through an intermediate position to a depressed position. A link member interconnects the push bar and the reciprocating member. When the push bar moves from the intermediate to the depressed position, it operates the reciprocating member to trigger the latch mechanism. A catch member operates to limit movement of the push bar between the intermediate and depressed positions but can be released to allow the push bar to move to the extended position. When the push bar is in the intermediate position, it is flush with the door muntin.

### FIELD OF THE INVENTION

The present invention broadly concerns latch and release mechanisms for doors. The present invention particularly concerns latch and release mechanisms for doors, including glass panel doors and the like. This invention specifically concerns an emergency release or break-away latch assembly for automatic sliding doors, but the invention also may apply to swinging doors.

### BACKGROUND OF THE INVENTION

Various closure structures have been associated with the entryways of dwellings and buildings throughout history. These closure structures range from simple draped fabrics to a standard hinged door and to more elaborate mechanical devices that are used in commercial applications. Many simple closure structures do not include latch and/or locking capabilities. On the other hand, more elaborate structures can include a variety of components which secure the door and position and control access to the entryway.

In modern commercial buildings, automatic doors have become commonplace. Automatic doors are typically electronically operated so that, as a person approaches, the door moves from a closed position to an open position. Automatic doors typically respond to an input signal that senses the presence of a person. In the early days of automatic doors, a pressure pad was placed in front of the door on the walking surface. When a person steps on the pressure pad, the weight of the person closes a switch that sends a signal to the door operating mechanism to cause that mechanism to open the door. In more recent years, motion and proximity to detectors have been used to determine the presence of a person at the entryway. When a person enters the sensor zone, a signal is produced that causes the door operating mechanism to open the door.

In earlier days, automated doors typically were swinging doors that were hinged, along a vertical edge and swung between the open and closed positions similarly to a standard household door. In the event of a power outage, the door could forcefully be swung to an open condition to allow emergency entry or exit through the door. This is because the mechanics of the door could be overcome by torque applied to the edge of the door opposite the vertical hinged location.

In more recent times, automated sliding doors have proliferated. Automated sliding doors are typically constructed as a unit wherein a slide panel is slightly offset from but is parallel to a fixed panel. The slide panel slides relative to the fixed panel to create a doorway opening for ingress and egress. Often, a pair of such units are placed in end to end relation so that the slide panels abut one another in a common plane. In such configurations, the presence of an operative signal causes both slide panels to slide away from one another presenting a doublewide entryway opening for ingress and egress.

While the closing force of a traditional automated swinging door can be manually overcome, it is more difficult to overcome the closing force of an automatic sliding door. This could potentially cause a problem should power fail to be supplied to an automated door. This can occur in situations such as power outages, fires and the like. Since it is desirable to permit persons located within the building to exit the building under such circumstances, it is known to provide automatic sliding doors with a breakaway capability. Here, in addition to its sliding capability, the sliding door is mounted on a hinge or pivot that defines a vertically oriented axis for swinging motion of the sliding door. A latch mechanism is located along an opposite edge of the door with this latch mechanism normally retaining the sliding door in its normally closed position. A manually actuable release mechanism is then associated with the door such that, upon activation, the release mechanism operates the latch mechanism to release the sliding door so that it may pivot along the vertical axis in a manner of a normal door. This feature is called a “break-away capability”.

Traditional automatic slide doors with break-away capability suffer from a disadvantage, however. In automatic sliding door configurations it is normally desirable that the slide panel be located exteriorly of the fixed panel. However, if so mounted, the break-away activation mechanism on the slide panel can interfere with the ability of the slide panel to undergo reciprocal sliding movement do to the physical dimensions of the release mechanism. For this reason, where an automatic slide door is provided with break-away capability, it is known to mount the slide panel in the less desirable interior location so that the release mechanism, located on the interior side of the side panel, does not interfere with the reciprocal sliding motion.

Accordingly, there has been a long felt need for an emergency release assembly and a sliding door assembly that incorporates the same, that permits the release assembly to be mounted on the interior side of the sliding panel yet which also is constructed so as to allow the slide panel to be positioned on the exterior side of the fixed panel of an automatic sliding door. The present invention addresses this need.

### SUMMARY OF THE INVENTION

It is an object of the present invention to provide a new and useful emergency release assembly adapted for use on a door structure as well as a door structure incorporating such an emergency release assembly.

Another object of the present invention is to provide a new and useful emergency release assembly adapted for use in a sliding door as well as a sliding door incorporating such an emergency release assembly.

It is another object of the present invention to provide an emergency release assembly that fits entirely within the geometric extension of the surface of a sliding door muntin during normal use.

It is a further object of the present invention to provide an emergency release mechanism for a sliding door that can be provided as original equipment for a sliding door or that may be retrofit into many types of existing sliding doors assemblies.

Yet another object of the present invention is to provide an emergency release mechanism and sliding door incorporating the same where the mechanism normally fits entirely within the recess of a muntin yet which may be manually tripped so that it may be expanded for ease of installation, maintenance and repair.

Still another object of the present invention is to provide an emergency release assembly and sliding door incorporating the same that is simple and reliable in construction and operation.

According to the present invention, then, an emergency release assembly is disclosed that is adapted for use with a door that is supported by a framework when in a normally closed configuration yet that is moveable in an emergency condition between the normally closed configuration and an emergency open configuration. This emergency release assembly is especially incorporated, according to the present invention, in a sliding door system with break-away capability wherein the sliding door system includes a fixed panel oriented in the first plane a guide structure extending parallel to the fixed plane and a carriage piece disposed in the guide structure for sliding movement relative to the fixed panel. A sliding door is secured to the carriage piece so that the door slidingly moves with the carriage piece between a slideable closed position relative to the fixed panel and a slideable open position relative to the fixed panel and wherein the sliding door is also pivotally mounted with respect to the carriage piece so that it may pivot between a normally closed configuration and an emergency open configuration.

The release assembly according to the present invention, whether for a swinging door or a sliding door, includes a latch mechanism that is operative in the first state to retain the door in the normally closed position and is actuable to a second state that allows the door to be moved to an open position. The release assembly also includes a release mechanism that is operative to advance the latch mechanism from the first state to the second state. The release mechanism includes a reciprocating control member coupled to the latch mechanism and supported by the door for reciprocal sliding movement. A manually actuable push bar is provided and at least one link member interconnects the push bar and the reciprocating member in a manner such that the push bar may be moved between a fully extended position and a depressed position through an intermediate extended position. When the push bar is moved from the intermediate extended position to the depressed position, it operates to move the reciprocating member such that the latch mechanism is advanced from the first state to the second state. A catch member is provided that operates in a retained state to limit movement of the push bar between the intermediate extended position and the depressed position yet the catch member is releasable to an access state when the push bar can move from the intermediate position to the fully extended position. This release mechanism can be used as a primary latch and release assembly for a door as an emergency or “one-way” release.

In the disclosed embodiment, the link member is defined by a scissors unit formed by first and second legs that are pivotally interconnected to one another. Specifically, a pair of link members interconnect the push bar and the reciprocating members with these link members being positioned and spaced apart in relation to one another. In each case, both link members are then defined by a scissors unit. Whether using one or a plurality of scissor units, the first leg of each scissor unit has a proximal end secured to the reciprocating member and a distal end opposite the proximal end. A second leg then has a proximal end secured relative to the door and a distal end secured to a medial portion of the first leg. A mounting plate is supported on the distal end of the first leg and the push bar may be secured to the mounting plate. Thus, depression of the push bar causes the scissor units to collapse and expand thereby moving the reciprocating member relative to the door.

In the disclosed embodiment, the latch mechanism includes a reciprocating latch actuator rod, and the release mechanism includes a rotatable drive element and a crank arm. The crank arm has a first crank arm end that is secured to the reciprocating member and a second crank arm end secured to the drive element such that reciprocation of the reciprocating member acts to reciprocally rotate the drive element the actuator rod has a first rod end secured to the drive element whereby reciprocal rotation of the drive element acts to reciprocate the actuator rod. The first crank arm end moreover may be slideably secured to the reciprocating member such that the drive element is not rotated when the push bar moves from the intermediate extended position to the fully extended position. In the disclosed embodiment, the push bar is biased toward the fully extended position. This is accomplished by means of a return spring mounted on the legs of the scissor unit(s) which biases them into an extended position.

In the disclosed embodiment, the release mechanism includes a base member that is adapted to be supported by the door, such as by slide channels formed within the muntin recess. The link member or members interconnect the base member and the reciprocating member for reciprocal motion of the reciprocating member relative to the base member. The catch member is defined by a lever that is pivotally secured to the base member with the lever including a lever arm section that interacts with the scissor unit to limit movement thereof so that is may not move from the intermediate extended position to the fully extended position when in the retained state. This lever is pivotable out of the retained state so that the scissor assembly may expand to the fully extended position. The push bar then has an access opening whereby the lever may be manually pivoted out of the retained state.

As noted, the release mechanism is adapted to be disposed in the muntin recess of a sliding door so that, when the push bar is in the intermediate extended position and in the depressed position, it is captured completely within the interior of the recess so that the push bar does not protrude outwardly therefrom. The catch member retains the push bar within the muntin recess but, when moved to the access state, allows the push bar to extend out of the recess when in the fully extended position thereby to allow access for installation and maintenance.

The present invention also is directed to a sliding door incorporating a latch mechanism and a release mechanism, as described above. Here, the sliding door includes a framework that has a muntin. A latch mechanism is disposed in the framework and operates in the first state to retain the sliding door in the normally closed configuration yet which is actuable to a second state that allows the sliding door to be moved to the emergency open configuration. A release mechanism is then disposed in the muntin and operates to advance the latch mechanism from the first state to the second state. The release mechanism includes a control member coupled to the latch mechanism and supported for reciprocal sliding movement, a push bar at least one link member interconnecting the push bar and the control member and a catch member, all as described above.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a diagrammatic front plan view of a sliding door assembly according to the present invention located within a representative entryway of a building and viewed from the interior of the building with a pair of sliding doors thereof shown in a normally closed condition and with the door assembly closing the entryway;

FIG. 2 is a front view in elevation, similar to FIG. 1, but showing the pair of sliding doors opened to allow access to the entryway of the building;

FIG. 3 is a top plan view taken about lines 3-3 of FIG. 1 showing a representative slide door unit with the slide door in the normally closed position;

FIG. 4 is a top plan view, similar to FIG. 3, but showing the slide door in an emergency open or “break-away” configuration;

FIG. 5 is a perspective view of the top portion of a slide door and break out arm according to the present invention;

FIG. 6 is a perspective view of the top corner portion of a sliding door shown in FIG. 5 broken away to reveal the latch mechanism with the latch mechanism in a first state that retains the sliding door in the normally closed position;

FIG. 7 is a perspective view, similar to FIG. 6, but showing the latch mechanism actuated to second state that allows the sliding door to be moved to the emergency open configuration;

FIG. 8 is cross-sectional view showing the muntin of a sliding door;

FIG. 9 is an exploded perspective view of the muntin and no stile of the present invention receiving the latch mechanism and the release mechanism according to a first exemplary embodiment of the present invention;

FIG. 10 is an exploded perspective view showing the release mechanism according to the present invention;

FIG. 11(a) is an exploded perspective of a scissor unit forming a representative link member;

FIG. 11(b) is perspective view showing a link member in the form of a scissor unit according to the present invention;

FIG. 12(a) shows a cross-sectional view of the push bar and release mechanism of the present invention installed in the muntin and illustrated in an intermediate extended position;

FIG. 12(b) is a front view in elevation showing a portion of the release mechanism of the present invention in the intermediate extended position;

FIG. 13(a) is an end view in elevation, similar to FIG. 12(a), but showing the push bar and release mechanism in the depressed position;

FIG. 13(b) is a front view in elevation, similar to FIG. 12(b), but showing the release mechanism in the depressed position;

FIG. 14(a) is a top plan view showing a link member in the form of a scissor unit and catch member with the catch member in the retain state and the scissor unit in the intermediate extended position;

FIG. 14(b) is a top plan view, similar to FIG. 14(a), but showing the catch member in an access state such that the scissor unit and the push bar connected thereto is in the fully extended position;

FIG. 15 is a side view in elevation showing the push bar and release mechanism in the fully extended position;

FIG. 16 is a front view in elevation showing a second exemplary embodiment of the present invention employing the emergency release assembly with a swinging door;

FIG. 17 is a perspective view of the top of the swinging door of FIG. 16 with the door panel in the normally closed position;

FIG. 18 is a perspective view of the top of the swinging door, similar to FIG. 17, but showing the door panel in the emergency open position;

FIG. 19 is a front view in elevation showing a third exemplary embodiment of the present invention employing the release assembly and latch mechanism as the primary latch for a swinging door shown in a closed position; and

FIG. 20 is a side view in elevation showing the swinging door of FIG. 19 moving to an open position.

### DETAILED DESCRIPTION OF THE EXEMPLARY EMBODIMENTS

The present invention broadly concerns door closures used with respect to the entryways of dwellings and other buildings. The present invention, however, is specifically directed to a sliding door assembly such as that used in many commercial establishments. It specifically concerns mechanisms, and doors incorporating those mechanisms, which are automated but which have an emergency break-away capability. However, while the present invention is described with respect to an automatic sliding door assembly, it should be understood that this invention may be used in any application where an emergency break-away capability is desired, even on non-sliding doors. Moreover, the present structure may also be used for the primary latching of a door without break-away capability. It should be further understood that the present invention is contemplated to be manufactured as original equipment with such a sliding door, but also may be constructed for retrofit capability.

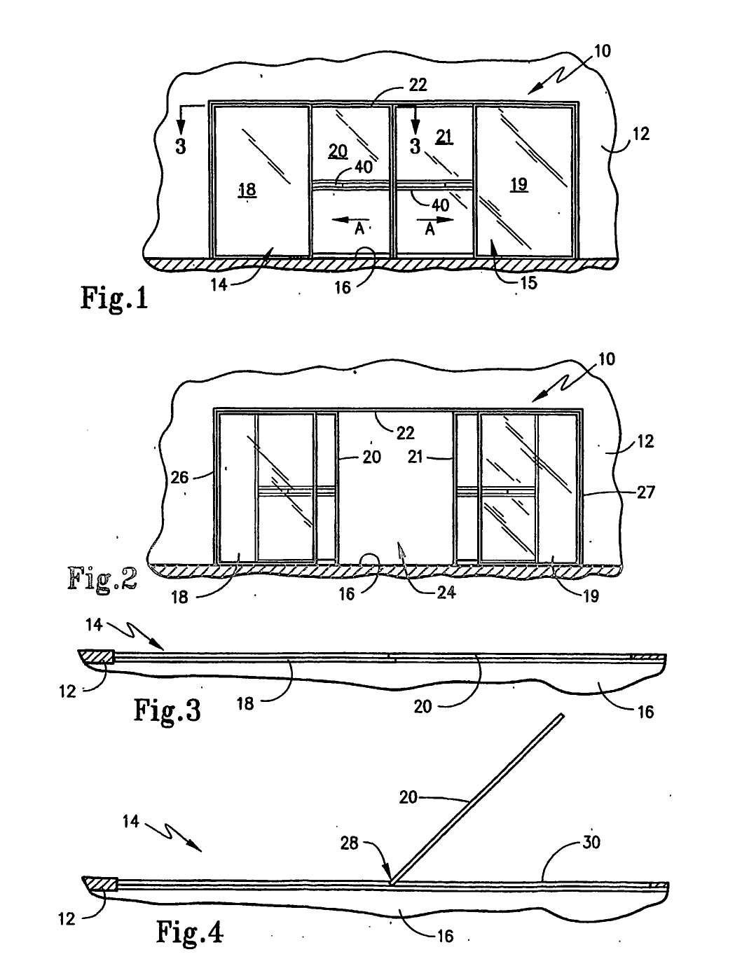

With these concepts in mind, a sliding door system having many features according to the prior art but also incorporating the structure of the exemplary embodiment of the present invention is introduced in FIGS. 1-4. In these figures, however, little, if any, of the detail of the new and useful emergency release assembly according to this invention is depicted. However, the structure shown in these figures assists in the understanding of the operation of the present invention.

Turning first to FIGS. 1 and 2, a sliding door system 10 is shown mounted in a wall portion 12 of a representative structure, such as a commercial building, having a floor 16. Sliding door system 10 includes a pair of sliding door units 14 and 15. Sliding door unit 14 includes a fixed panel in the form of a glass pane 18 and a sliding door 20 which is mounted for sliding movement with respect to panel 18 on a rail 22. Likewise, sliding door unit 15 includes a fixed panel 19, again in the form of a glass panel, and a sliding door 21 that slides relative to panel 19 on rail 22. As is shown in FIG. 1, sliding doors 20 and 21 are in a normally closed position such that, when slid together abut one another generally in a common plane. In FIG. 2, however, sliding doors 20 and 21 have been slid in the direction of arrows “A” (FIG. 1) to open thereby allowing access through an entryway 24. Generally speaking, each of fixed panels 18 and 19 as well as sliding doors 20 and 21 are mounted in a framework that includes guide rail 22 and side frame pieces 26 and 27, although this exact structure is not necessary for an appreciation of the present invention.

Turning to FIGS. 3 and 4, representative sliding door unit 14 is depicted, and it may be seen especially in FIG. 3 that fixed panel 18 is oriented generally in a first plane while sliding door 20, when in a normally closed configuration is oriented in a second or slide plane that is in closely spaced parallel relation to the plane of fixed panel 18. With reference next to FIG. 4, however, it may be seen that sliding door 20 can pivot into an emergency open configuration to allow emergency egress through entryway 24, if necessary. To this end, sliding door 20 pivots about a hinge 28 that interconnects door 20 to a breakout arm 30, as is known in the art. The construction of sliding door 15 is substantially identical to that of sliding door unit 14 except that the structure is symmetrical or forms a mirror image of that described with respect to FIGS. 3 and 4, so that the details of that structure are not again repeated.

As noted in the background of this invention, the typical sliding door unit with breakaway capability requires that the sliding door 20 be located interiorly of the building relative to the affixed panel. In FIGS. 1-4, however, the present invention allows the sliding panel to be located exteriorly of the building by virtue of the emergency release assembly of the present invention.

To understand this emergency release assembly, reference is made to FIGS. 1 and 5-7 where it may be seen that representative sliding door 20 has a frame that includes a hinge stile 32 and a nose stile 34 that are interconnected by top and bottom frame pieces 36 and 38. A central, horizontal muntin 40 extends between nose stile 34 and hinge stile 38 midway between frame pieces 36 and 38 so as to support a pair of glass panels 42 as is known in the art. With reference to FIGS. 5-7, it may be seen that nose stile 34 has a latch mechanism 44 disposed therein with this latch mechanism being adapted to engage a catch 46 that is part of breakout arm 30, as is known in the art.

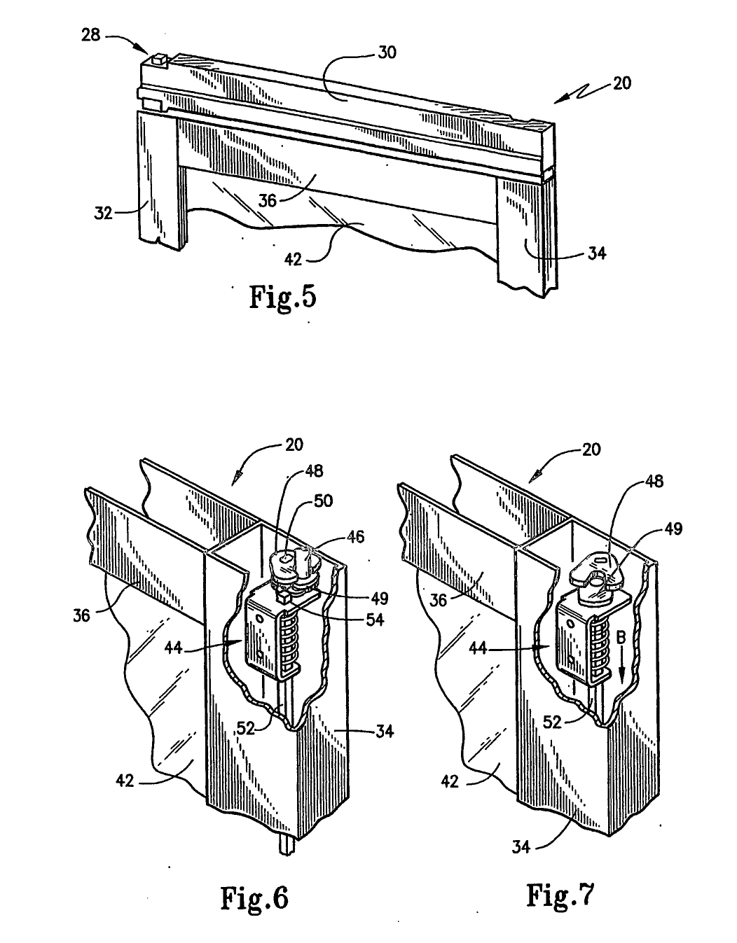

Latch mechanism 44 is of a type described in U.S. Pat. No. 4,368,905, the disclosure of which is incorporated herein by reference. Broadly, latch mechanism 44 includes a spring loaded, U-shaped latch piece 48 that is pivotally mounted on shaft 50. When latch piece 48 engages catch 46, as is shown in FIG. 6, an end 54 of latch rod 52 abuts tongue 49 of latch piece 48 to maintain engagement with catch 46 so that the door 20 may not be moved into the emergency open position. However, as is shown in FIG. 7, when latch rod 52 is moved downwardly a small distance in the direction of arrow “B” end 54 moves out of this blocking engagement so that latch piece 48 may flip to a release position thereby disengaging the catch 46 allowing door 20 to pivot into the emergency open position. When the door 20 is moved from the emergency open position toward the normally closed position, the pressure of catch 46 against latch piece 48 again moves it into the position shown in FIG. 6 allowing rod 52 to move upwardly in the direction opposite arrow “B” to again secure the door in the normally closed position.

From this description, it should now be apparent to the ordinarily skilled artisan that, to release door 20 for pivoting motion, it is only necessary to toggle rod 52 a sufficient amount to move end 54 out of abutment with tongue 49. This is normally accomplished by a release mechanism that is mounted in the muntin 40 of the door. However, the dimensions of such a release mechanism disposed in the muntin has here to for been too great to fit within the geometric projection of the face of the muntin, a problem resolved by the present invention.

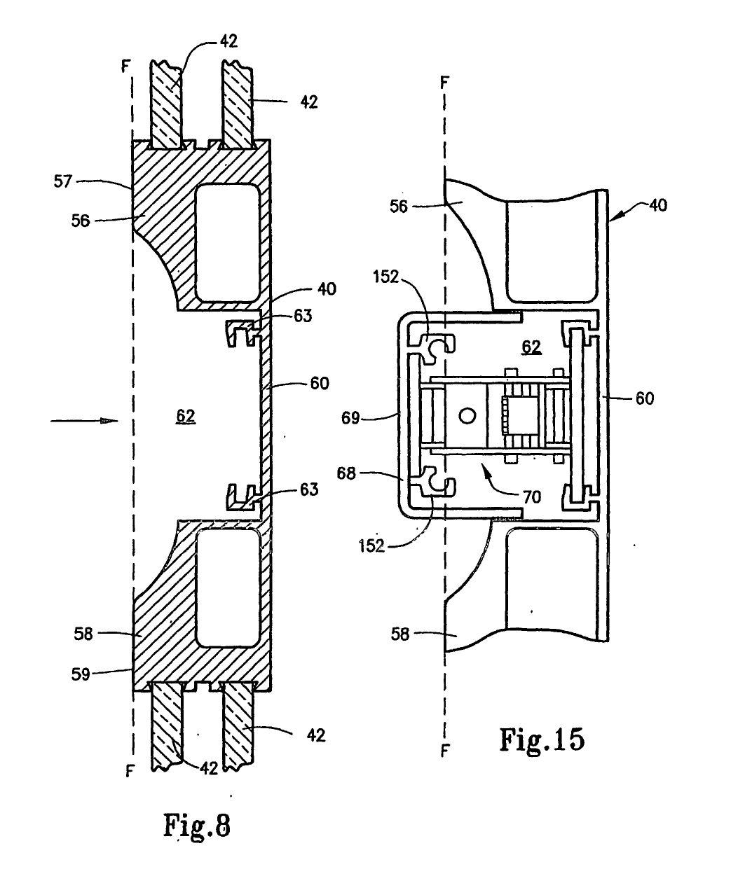

Turning, then, to FIG. 8, it may be seen that a representative muntin 40 is in the form of an extrusion, such as aluminum, that includes a pair of opposed muntin sections 56 and 58 that are adjoined by a web piece 60 as an integral one piece extrusion. Upper and lower muntin sections 56 and 58 define a recess 62 therein within which the release mechanism, described below, is to be mounted. To this end, muntin 40 concludes a pair of spaced apart ribs 64 that form facing channels to receive the release mechanism as described below. In any event, muntin sections 56 and 58 respectively have front surfaces 57 and 59 that define a substantially plainer outer muntin face “F”, as is shown in FIG. 8. In order for the sliding doors 20 and 21 to be mounted exteriorly of fixed panels 18 and 19, respectively, it is necessary that the release mechanism, during operation, fit entirely within recess 62 as bounded by web 60 and plane “F” that may also be termed the geometric projection of front surfaces 57 and 59 that define plane “F”.

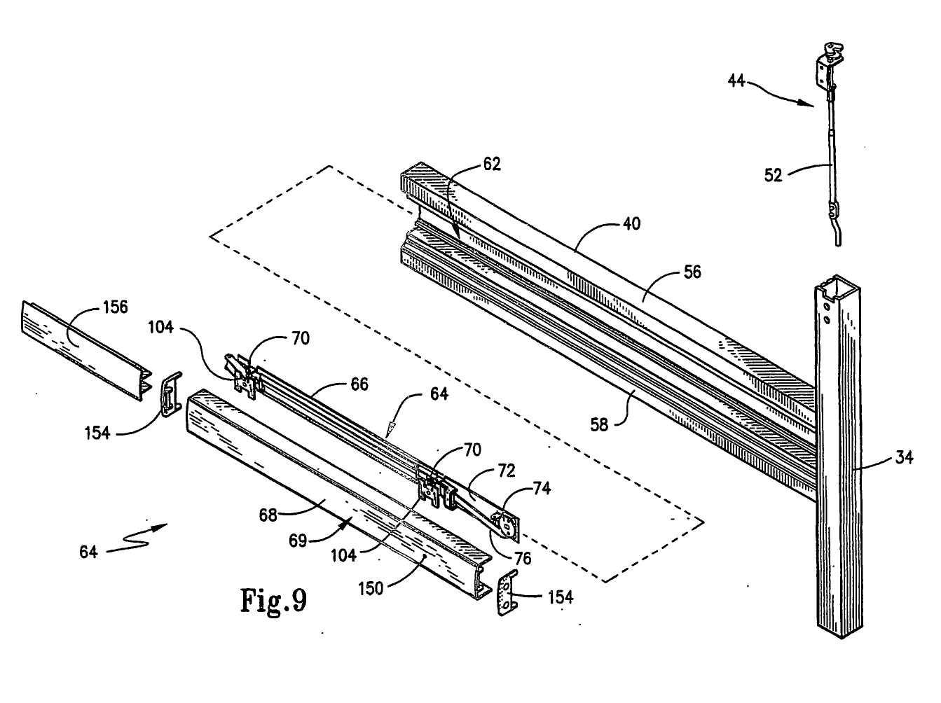

The release mechanism 64 according to the exemplary embodiments of the present invention is introduced in FIG. 9 where it may be seen that release mechanism 64 includes a control member 66 in the form of a reciprocating piece, a push bar 68 and a pair of link members 70 that interconnect push bar 68 and reciprocating control member 66. In this exemplary embodiment, these pieces are mechanically secured to a base member 72 that is slideably engageable in the channels formed by ribs 63. In its more detailed construction, release mechanism 64 also includes a rotatable cam drive element 74 that is linked to control member 66 by means of a crank arm 76 slid into and supported in recess 62.

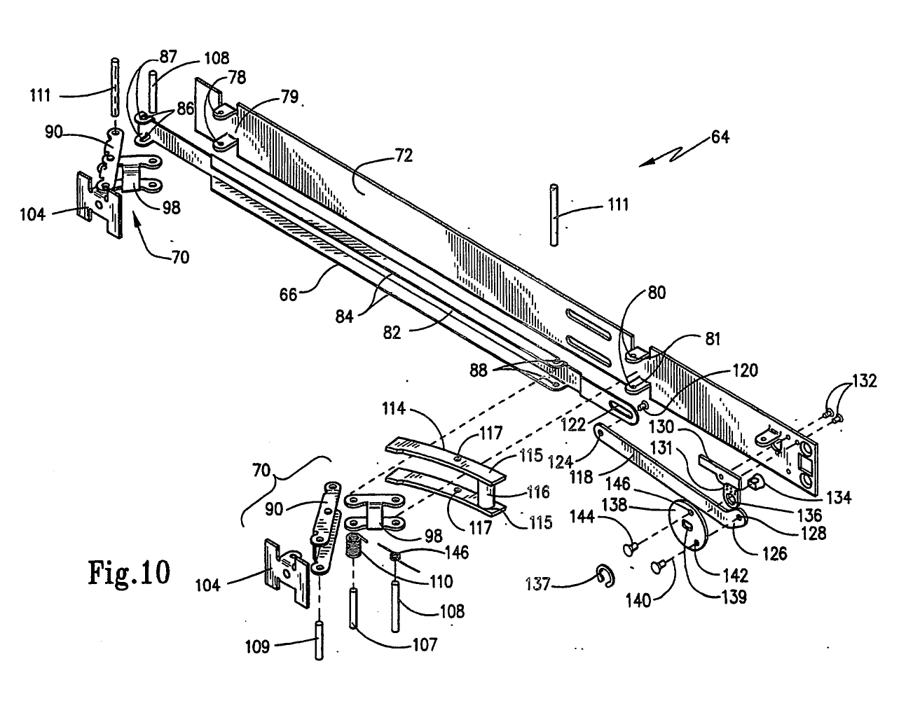

The elements and construction of release mechanism 64 is shown in greater detail in FIG. 10. In this figure, it may be seen that base member 72 is in the form of a metallic strip or plate that has a first pair of ears 78 adjacent a first end thereof. Ears 78 are stamped out of the material of base member 72 and are bent generally perpendicularly thereto to form a pair of opposed pin supports, as defined below. Accordingly, each of ears 78 has a hole 79 formed therethrough. A second pair of ears 80 having holes 81 are similarly formed at a second end portion of base member 72 to again form opposed supports for an axle pin, as described below. Reciprocating control member 66 is in the form of a channel shaped piece that includes a bottom wall 82 and a pair of opposed sidewalls 84 that extend a majority of the length of bottom wall 82. Control member 86 has a pair of spaced apart ears 86 having holes 87 formed at a first end thereof to form axle mounts, again as described below. Sidewalls 84 have a pair of spaced apart holes 86 formed at an end thereof that is opposite ears 86. Control member 66 is sized and configured to be placed in confronting relationship with base member 72 so that it may slide in a longitudinal direction between ears 78 and 80 alongside the surface of base member 72.

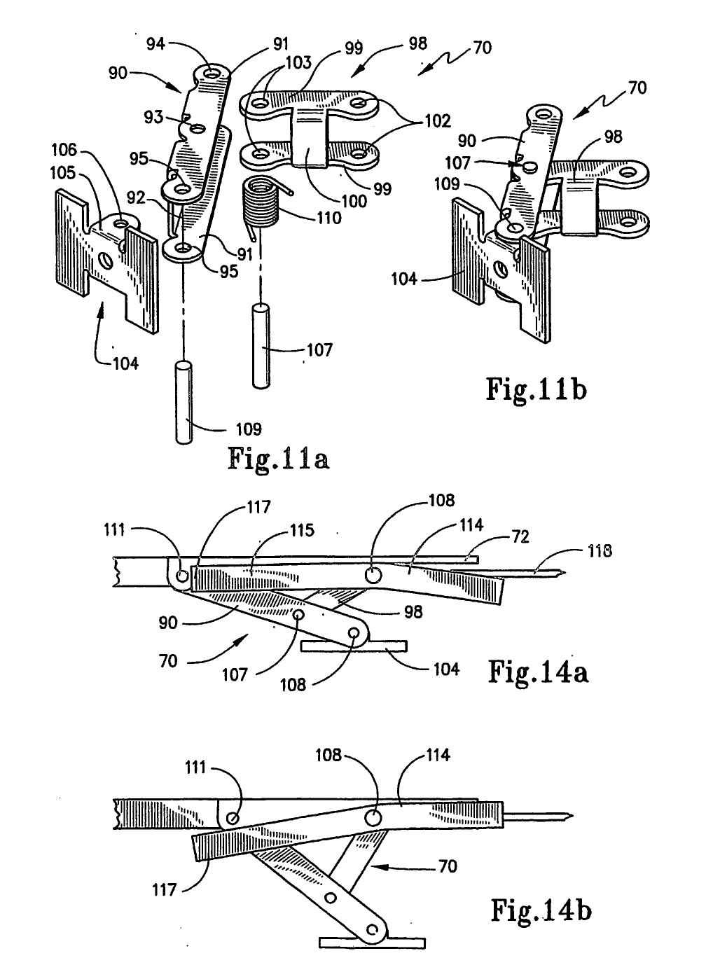

A pair of link members in the form of scissor units 70 operate to link base member 70 to reciprocating control member 66. In FIG. 10, one such scissor unit 70 is shown in an assembled configuration while the other scissor unit 70 is shown in an exploded perspective. The structure of a scissor unit 70 is depicted in greater detail, also, in FIGS. 11(a) and 11(b). In either case, it may be seen that each scissor unit 70 is formed by a first leg 90 and a second leg 98. Each first leg 90 includes a pair of leg sections 91 that are in generally parallel spaced apart relation to one another and are interconnected by a web 92. A central hole 93 is located on each leg section 91 and opposite end holes 94 and 95 are located at opposite ends of each leg section 91. Second leg 98 includes a pair of leg sections 99 that are in generally parallel spaced relation to one another and are joined by a web 100. Each leg section 99 includes end holes 102 and 103. A mounting plate 104 is provided and includes ears, such as ears 105 having holes 106 having a hole 106 therethrough. In addition, scissor unit 70 includes two axle pins 107 and 109 along with a torsion spring 110.

Scissor unit 70 is shown in FIG. 11(b) in an assembled state. Here, it may be seen that end holes 103 of second leg 88 have been co-axially aligned so that the distal end of each leg section 99, corresponding to end holes 103, are pivotally secured to a medial portion of first leg 90, and specifically, to a medial portion of leg sections 91 by means of axle pin 107. Here, also, it should be understood that axle pin axially receives torsion spring 110 thereon with torsion spring 110 being positioned between the leg sections 99. The ends of torsion spring 110 bear against webs 92 and 100 so as to bias legs 90 and 98 into an expanded or fully extended position. Mounting plate 104 is secured to the distal end of first leg 90 by axially aligning holes 95 and 106 together with ears 105 being positioned between leg sections 91. Mounting plate 104 is then secured by means of axle pin 109. In this manner, legs 90 and 98 may pivot relative to one another about axle pin 107 while mounting plate 104 may pivot relative to first leg 90 by means of axle pin 109.

Further construction of release mechanism 64 may be seen with reference again to FIG. 10. In interconnecting control member 66 to base member 72, it may now be appreciated that this is accomplished by means of a pair of axle pins 108 and 111. Specifically, after the assembly of a scissor unit 70, the proximal end of first leg 90 is secured to control member 66 by placing ears 86 between leg sections 91 and pivotally securing them by axle pin 111 passing through holes 87 and holes 94. The proximal end of second leg 98 is secured to base member 72 by placing the proximal end of second leg 98 between ears 78 and pivotally securing them together by means of axle pin 108 which passes through holes 79 and end holes 102. The second scissor unit 70 is secured in a similar manner with the proximal end of its first leg 90 being secured at the end of sidewalls 88 by connecting the proximal end portion of leg sections 91 with an axle pin 111 passing through holes 88 and end holes 94. The proximal end of the respective second leg 98 is secured to ears 80 by means of axle pin 108 which extends through holes 81 and end holes 102.

With continued reference to FIG. 10, it should also be understood that a catch member 114 is provided and is generally U-shaped in configuration having a pair of spaced apart, generally parallel arm sections 115 joined by a web 116 at one end thereof. Arm sections 115 are provided with medial holes 117 sized to receive a respective axle pin 111. Thus, catch member 114 is mounted for pivotal movement on a common axle pin 111 as is the proximal end of a respective second leg 98.

Reciprocating control member 66 is used to operate actuator rod 52. To this end, a crank arm 118 is connected to an end of control member 66 by means of pin 120 passing through a slot 122 and being press fit into a hole 124 formed in the proximal end of crank arm 118 the distal end of crank arm 118 is formed as an angled foot 126 that has a hole 128.

Base member 172 has a bracket 130 secured thereto by means of rivets 132. Bracket 130 supports a shaft 134 through a hole 136 formed in an offset lobe 131 of bracket 130. A cam disk 138 is then rotatably journaled relative to bracket 132 by being pressed fit on a rectangular head of shaft 134 by way of a central rectangular opening 139 formed in the center of disk 138, and it may be secured by clip 137. A pin 140 then attaches foot 126 of crank arm 118 to cam disk 138 by extending through a hole 142 and mating with hole 128.

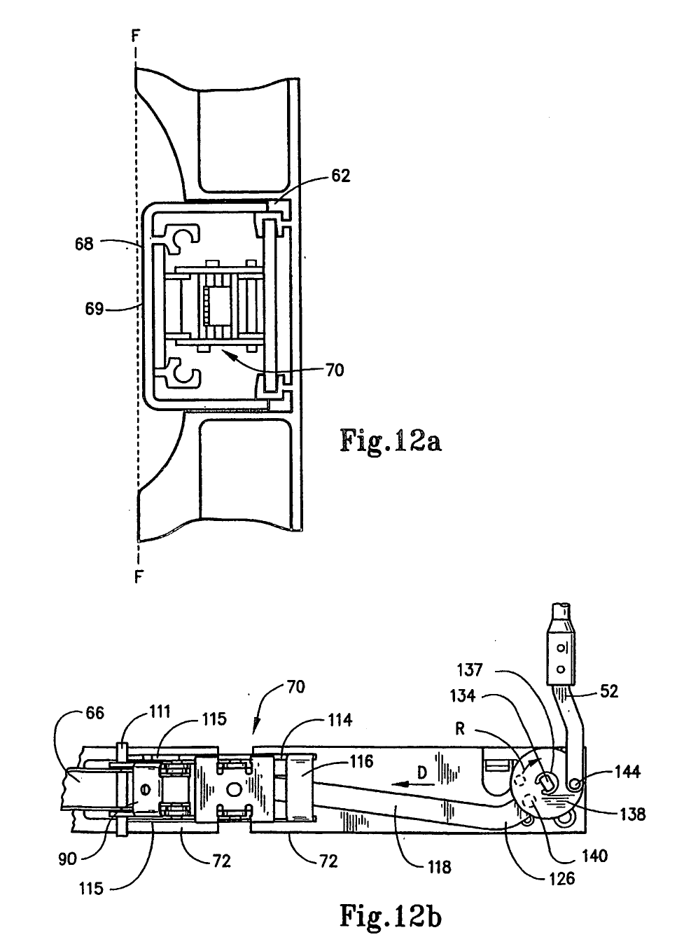

A post 144 is secured to disk 138 by means of a hole 146 in order to attach the latch actuator rod 52. This assembled unit may further be viewed in FIG. 12(b), as discussed below.

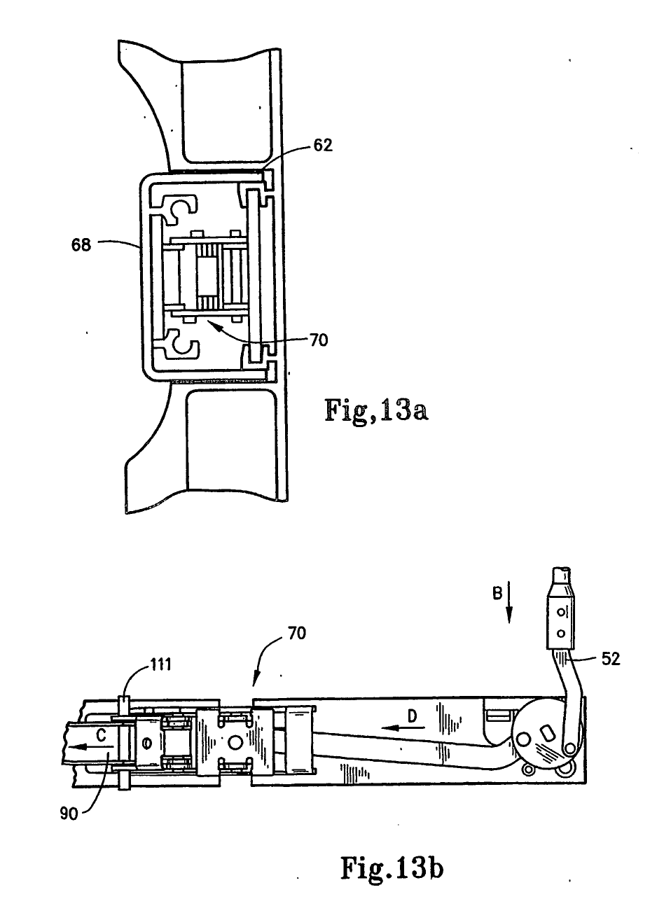

The operation of release mechanism 64 may now be more fully appreciated with reference to FIGS. 12(a), 12(b), 13(a) and 13(b). In FIGS. 12(a) and 12(b), release mechanism 64 is shown in a condition wherein the push bar 68 and the scissor units are in an intermediate extended position. In this position, push bar 68 has an outer face 69 that is substantially co-planer with muntin plane “F”. Push bar 68 and scissor units 70 are held in this position since the ends of arm sections 115 of catch member 114 that are located oppositely web 16 are in abutment with axle pin 111. Catch member 114 is biased into a position wherein abutment occurs by means of a biasing spring 146 that extends around axle pin 108 which mounts the proximal end of the section leg section 98 to base member 72. However, when push bar 68 is depressed so that it moves into muntin recess 62, as is shown in FIG. 13(a), the scissor units 70 are compressed which results in a separation of the proximal ends of each of legs 90 and 98. When the proximal ends of legs 90 and 98 move apart, control member 66 is moved to the left, as is shown by arrow “C” in FIG. 13(b). When this occurs, crank arm is drawn to the left, as is shown by arrow “D” since pin 120 is in the right hand location in slot 122.

Movement of crank arm 118 to the left, in the direction of arrow “D” causes a rotation of disk 138 in the direction of arrow “R” as is shown in FIG. 13(b). When this happens, actuator rod 152 moves downwardly in the direction of arrow “B”. This action, as discussed with reference to FIGS. 6 and 7, acts to release latch mechanism 44. Releasing push bar 68 from this depressed position, as is shown in FIG. 13(a) causes it to move back to the intermediate extended position as shown in FIG. 12(a). This is due to the action of return torsion springs 110 acting to expand scissor units 70 so as to move the proximal end portion of legs 90 and 98 closer together. This action can occur as a result of either of two conditions. First, if latch piece 48 has pivoted to the position shown in FIG. 6, control rod 52 can move upwardly which causes cam disk 138 to rotate. Alternatively, due to the configuration of slot 122, even if latch piece 48 is in the position shown in FIG. 7, torsion springs 110 can move the scissor units to the intermediate expanded position.

The illustration of a representative scissor unit 70 in the intermediate extended position is also shown in FIG. 14(a). As is shown in FIG. 14(a), end 117 of a representative arm section 115 is in abutment with axle pin 111. Thus, the portion of arm section 115 between pin 108 and pin 111 is in compression which prevents further movement of the proximal ends of legs 90 and 98 to move closer together. This prevents further expansion of scissor units 70 to the fully extended position. However, pivoting catch member 114 to move end portions 117 out of abutment with axle pin 11, as is shown in FIG. 14(b) allows scissor units 70 to move to the fully extended position. When this occurs, push bar 68 can move to the fully extended position as is shown in FIG. 15. In this condition, push bar 68 moves and projects outwardly of recess 62 so that it is projected outwardly through muntin face plane “F”. This position facilitates assembly and disassembly of release mechanism 64 for assembly and maintenance purposes. In order, therefore, to pivot catch member 14, an access hole 150 is provided in face 69 of press bar 68 so that an instrument, such as a small prong or screwdriver, may be inserted through access opening 150 and pressed against web 16 to force catch member 114 to undergo this pivotal motion.

In assembling this device, reference may be made to FIGS. 8 and 9. Release mechanism 64 is inserted into muntin 40 by slideably positioning base member 72 so that it is engaged by ribs 63 and held in position. Next, push bar 68 is mounted on each of mounting plates 104 by means of internal ribs 152 as is shown in FIGS. 12(a), 13(a) and 15. End caps 154 may then be attached to press bar 68, such as by screws (not shown). If desired, a fill or cover plate 156 is to provide cover any region of recess 62 that is not covered by push bar 68.

A second exemplary embodiment of the present invention is shown in FIGS. 16-18 wherein an emergency release assembly the type described above is shown incorporated into a swinging door. It should be understood that this second embodiment is described with respect to a swinging glass door however other swinging door configurations, including wooden doors, are contemplated. Indeed, it should be appreciated by the ordinarily skilled person in this field that framework structures other than that described in FIGS. 16-18 could be employed and that the skilled artisan could modify existing structures in order to incorporate the emergency release assembly of the present invention. Thus, the swing door structure described herein is for illustrative purposes only.

With respect to FIG. 16, then, it may be seen that door 210 is shown in a normally closed position in an opening 212 formed in wall 214 above floor 216. Door 210 is hinged relative to wall 214 by a pair of hinges 218 so that it may swing from the normally closed position to the normally open position. Door 210 includes a primary frame 220 and a subframe 230. Primary frame 220 includes a pair of vertical pieces 222 and 224 with vertical piece 222 connected to hinges 218. A breakout piece or arm 226 is rigidly connected between the upper end portions of vertical pieces 222 and 224. In FIG. 16, a lock 250 is provided and secures mainframe 220 in a locked condition relative to wall 214.

Subframe 230 includes vertically extending hinge stile 232, a vertically extending nose stile 234, a top stile 236 and a bottom stile 238. A muntin 240 extends at a central location between hinge stile 232 and nose stile 234 equidistantly between top stile 236 and bottom stile 238. Muntin 240 is constructed similarly to muntin 40 described above. A glass panel 242 is mounted between muntin 240 and top stile 236 and extends between hinge stile 232 and nose stile 234. Similarly, a second glass panel 244 extends between muntin 240 and bottom stile 238 and between hinge stile 232 and nose stile 234. It should be understood, then, that swinging door 210 includes both frame 220 and subframe 230 as well as muntin 240 and glass panels 242 and 244.

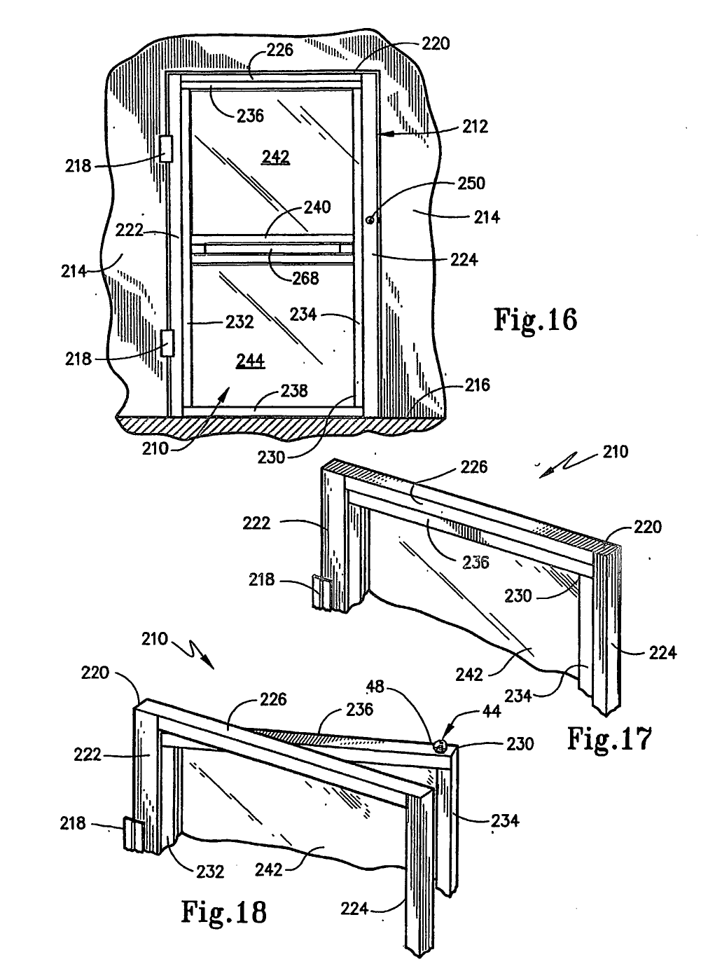

With reference to FIGS. 17 and 18, it may be seen that door 210 may move from a normally closed position to an emergency open condition even when door 210 is, for example, is closed and in a locked state as is shown in FIG. 16. However, as is shown in FIGS. 17 and 18, subframe 230 may pivot on hinge stile 226 to provide an emergency breakaway capability. Normally, sub-frame 230 is mounted co-extensively with mainframe 220. However, in an emergency release condition, push bar 268 (FIG. 16) may be depressed to actuate a release mechanism that is identical in structure to release mechanism 64 described with respect to the first exemplary embodiment. Activation of release mechanism 64 operates latch mechanism 44 that is identical in structure to that described above so as to release sub-frame 230 from a catch (not shown) located at the junction of hinge stile 226 and vertical piece 224 that is substantially identical to that described with respect to hinge stile 32 and catch 46, above. Upon activation, latch piece 48 releases so that subframe 230 may pivot out of mainframe 220 and thus allow egress even when door 210 is otherwise locked or prevented from opening as a result of electrical failure or otherwise.

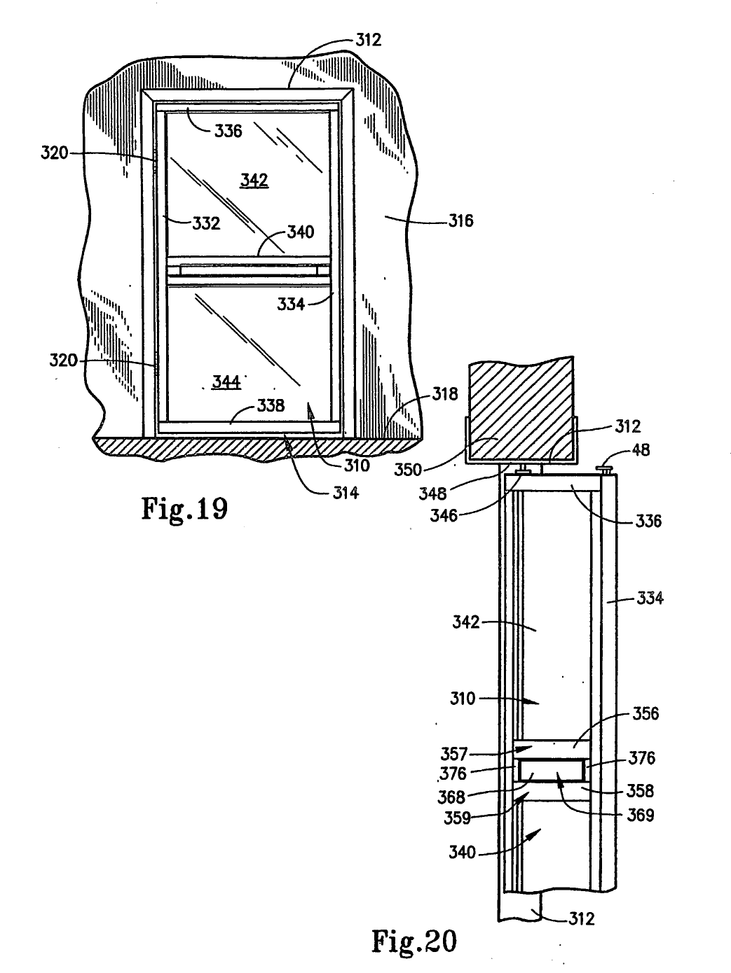

A third exemplary embodiment of the present invention is shown in FIGS. 19 and 20. Here, it should be understood that the present invention is used not as an emergency breakaway release but rather as the primary latch and release mechanism for a door. Thus, as is shown in FIG. 19, door 310 is shown mounted in a doorframe 312 that surrounds an opening 314 in walls 316 over a floor 318. Door 310 is mounted relative to frame 312 by means of a pair of hinges 320 so that it may swing between an open and closed state. Door 310 includes a hinge stile 332 a nose stile 334 a top stile 336 and a bottom stile 338. A muntin 340 extends between hinge stile 332 and nose stile 334 midway between top stile 336 and bottom stile 338 and supports a pair of glass panes 342 and 344.

With reference to FIGS. 19 and 20, it may be seen that header 350 mounts a catch 346 that is in the form of a post with an enlarged flat head, similar to catch 46 described above. Catch 346 is mounted to header 350 by means of a plate 348. When in a normally closed condition, such as shown in FIG. 19, door 310 includes a latch piece 48 (FIG. 20) that is adapted to latch door 310 in the closed position. Latch piece 48 is identical to that described with respect to the first and second exemplary embodiments of the present invention and is operated by a latch mechanism, such as latch mechanism 44 that is mounted in muntin 340 identically to that described with respect to latch mechanism 44 in muntin 40.

To this end, as shown in FIG. 20, muntin 340 includes muntin sections 356 and 358 that have front surfaces 357 and 359, respectively. A pushbar 368 is mounted in the muntin recess provided by muntin sections 356 and 358 and is flanked, on either side, by cover plates 376. It should be appreciated that the front surface 369 of pushbar 368 is co-planar with front surfaces 357 and 359 of muntin 340. Since all of this is identical to the structure described with respect to muntin 40, latch mechanism 44 and release mechanism 64, the detail does not need to be described again.

In any event, depression of pushbar 68, in a matter similar to that of pushbar 68, above, acts to release the latch mechanism 44 so that latch piece 48 may pivot to permit disengagement from catch 346 thereby allowing door 310 to pivot into an open position, as is shown in FIG. 20. When door 310 is again closed, latch piece 348 engages catch 346 and pivots and becomes latched by latch mechanism 44 so that door 20 is retained in the closed position until pushbar 368 is once again depressed.

From this description, it may be appreciated that the release mechanism and latch assembly of the present invention may be used for breakaway doors, but also it may be used as the primary latch and release mechanism for a typical swinging door of the type shown in 310 or any other structure, including a wood panel door. This mechanism may be used generally on any such swinging door structure but is especially useful for emergency exit doors or other doors where one-way passage is desired. In the latter case, a pushbar located on one side of the door allows a person on that side to egress, but does not allow ingress in the opposite direction without the provision of some other latch release mechanism.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiment of the present invention without departing from the inventive concepts contained herein.

We claim:

1. An emergency release assembly adapted for use in a door that is supported for motion in a framework when in a normally closed configuration yet movable in an emergency condition between the normally closed configuration to an emergency open configuration, said release assembly comprising:
(A) a latch mechanism operative in a first state to retain the door in the normally closed position and actuable to a second state that allows the door to be moved to the emergency open configuration; and
(B) a release mechanism operative to advance the latch mechanism from the first state to the second state, said release mechanism including
(1) a reciprocating member coupled to said latch mechanism and supported by said door for sliding movement;
(2) a push bar;
(3) at least one link member interconnecting said push bar and said reciprocating member such that said push bar may be moved between a fully extended position and a depressed position through an intermediate extended position, said push bar when moved from the intermediate extended position to the depressed position being operative to move said reciprocating member such that said latch mechanism is advanced from the first state to the second state; and
(4) a catch member operative in a retain state to limit movement of said push bar between the intermediate extended position and the depressed position yet releasable to an access state wherein said push bar can move from the intermediate extended position to the fully extended position.

2. An emergency release assembly according to claim 1 wherein said link member is defined by a scissors unit formed by at least first and second legs pivotally interconnected to one another.

3. An emergency release assembly according to claim 2 wherein said first leg has a proximal end secured to said reciprocating member with a distal end opposite said proximal end and said second leg having a proximal end secured relative to said door with a distal end thereof secured to a medial portion of said first leg.

4. An emergency release assembly according to claim 3 including a mounting plate supported on the distal end of said first leg, said push bar being secured to said mounting plate.

5. An emergency release assembly according to claim 1 including at least two link members interconnecting said push bar and said reciprocating member, said link members being positioned in spaced-apart relation to one another.

6. An emergency release assembly according to claim 5 wherein each of said link members is defined by a scissors unit.

7. An emergency release assembly according to claim 1 wherein said latch mechanism includes a reciprocating latch actuator rod, said release mechanism including a rotatable drive element and a crank arm, said crank arm having a first crank arm end secured to said reciprocating member and a second crank arm end secured to said drive element whereby reciprocation of said reciprocating member acts to reciprocally rotate said drive element, said actuator rod having a first rod end secured to said drive element whereby reciprocal rotation of said drive element acts to reciprocate said actuator rod.

8. An emergency release assembly according to claim 7 wherein said first crank arm end is slideably secured to said reciprocating member such that said drive element is not rotated when said push bar moves from the intermediate extended position to the fully extended position.

9. An emergency release assembly according to claim 1 wherein said push bar is biased toward the fully extended position.

10. An emergency release assembly according to claim 1 wherein said release mechanism includes a base member adapted to be supported by said door, said link member interconnecting said base member and said reciprocating member.

11. An emergency release assembly according to claim 10 wherein said link member is defined by a scissors unit formed by at least first and second legs pivotally interconnected to one another, said first leg having a proximal end pivotally secured to said reciprocating member by a first axle pin with a distal end opposite said proximal end and said second leg having a proximal end pivotally secured to said base member by a second axle pin with a distal end thereof secured to a medial portion of said first leg.

12. An emergency release assembly according to claim 11 wherein said catch member is defined by a lever pivotally secured to said base member by said second axle pin, said lever including an arm portion that abuts said first axle pin when in the retain state, said lever being pivotable so that said arm portion is pivoted out of the retain state whereby said push bar may move from the intermediate extended position to the fully extended position.

13. An emergency release assembly according to claim 12 wherein said push bar has access opening whereby said lever may be manually pivoted out of the retain state.

14. A release assembly adapted for use in a door that is movable between a closed position and an open position, the frame structure of said door including a centrally located muntin that has a muntin recess, said release mechanism comprising:
(A) a latch mechanism disposed on said frame structure and operative in a first state to retain the sliding door in the normally closed position and actuable to a second state that allows the sliding door to be moved to the open position; and
(B) a release mechanism adapted to be disposed in the muntin recess and operative to advance the latch mechanism from the first state to the second state, said release mechanism including
(1) a control member coupled to said latch mechanism;
(2) a push bar;
(3) at least one link member interconnecting said push bar and said control member such that said push bar may be moved between a fully extended position and a depressed position through an intermediate extended position, said push bar when moved from the intermediate extended position to the depressed position being operative to move said control member such that said control member advances said latch mechanism from the first state to the second state; and
(4) a catch member operative in a retain state to limit movement of said push bar between the intermediate extended position and the depressed position yet releasable to an access state wherein said push bar can move from the intermediate extended position to the fully extended position.

15. A release assembly according to claim 14 wherein said link member is defined by a scissors unit formed by at least first and second legs pivotally interconnected to one another.

16. A release assembly according to claim 15 wherein said catch member engages said control member and is operative to in the retain state to limit movement thereof.

17. A release assembly according to claim 16 wherein said push bar has access opening whereby said catch member may be manually moved out of engagement with said control member thereby to permit said push bar to move from the intermediate extended position to the fully extended position.

18. A release assembly according to claim 15 including a mounting plate supported on the scissors unit, said push bar being secured to said mounting plate.

19. A release assembly according to claim 14 including at least two link members interconnecting said push bar and said reciprocating member, said link members being positioned in spaced-apart relation to one another.

20. A release assembly according to claim 19 wherein each of said link members is defined by a scissors unit.

21. A release assembly according to claim 14 wherein said latch mechanism includes a reciprocating latch actuator rod, said release mechanism including a rotatable drive element and a crank arm, said crank arm having a first crank arm end secured to said reciprocating member and a second crank arm end secured to said drive element whereby movement of said control member acts to rotate said drive element, said actuator rod having a first rod end secured to said drive element whereby rotation of said drive element acts to reciprocate said actuator rod.

22. A release assembly according to claim 21 wherein said first crank arm end is slideably secured to said control member such that said drive element is not rotated when said push bar moves from the intermediate extended position to the fully extended position.

23. A release assembly according to claim 14 wherein said push bar is biased toward the fully extended position.

24. A sliding door supported for sliding motion in a doorway when said sliding door is in a normally closed configuration yet which is movable in an emergency condition between the normally closed configuration to an emergency open configuration, comprising:
(A) a framework including a muntin;
(B) a latch mechanism disposed in said framework and operative in a first state to retain the sliding door in the normally closed configuration and actuable to a second state that allows the sliding door to be moved to the emergency open configuration; and
(C) a release mechanism disposed in the muntin and operative to advance the latch mechanism from the first state to the second state, said release mechanism including
(1) a control member coupled to said latch mechanism and supported for reciprocal sliding movement;
(2) a push bar;
(3) at least one link member interconnecting said push bar and said control member such that said push bar may be moved between a fully extended position and a depressed position through an intermediate extended position, said push bar when moved from the intermediate extended position to the depressed position being operative to move said reciprocating member such that said latch mechanism is advanced from the first state to the second state; and
(4) a catch member operative in a retain state to limit movement of said push bar between the intermediate extended position and the depressed position yet releasable to an access state wherein said push bar can move from the intermediate extended position to the fully extended position.

25. An emergency release assembly according to claim 24 wherein said link member is defined by a scissors unit formed by at least first and second legs pivotally interconnected to one another.

26. An emergency release assembly according to claim 25 including at least two link members interconnecting said push bar and said reciprocating member, each of said link members defined by a scissors unit formed by at least first and second legs pivotally interconnected to one another and being positioned in spaced-apart relation to one another.

27. An emergency release assembly according to claim 26 wherein each said first leg has a proximal end secured to said control member with a distal end opposite said proximal end and said second leg having a proximal end secured relative to said door with a distal end thereof secured to a medial portion of a respective said first leg.

28. An emergency release assembly according to claim 27 including a mounting plate supported on the distal end of each said first leg, said push bar being secured to said mounting plate.

29. An emergency release assembly according to claim 24 wherein said latch mechanism includes a reciprocating latch actuator rod, said release mechanism including a rotatable drive element and a crank arm, said crank arm having a first crank arm end secured to said control member and a second crank arm end secured to said drive element whereby reciprocation of said control member acts to reciprocally rotate said drive element, said actuator rod having a first rod end secured to said drive element whereby reciprocal rotation of said drive element acts to reciprocate said actuator rod.

30. An emergency release assembly according to claim 29 wherein said first crank arm end is slideably secured to said control member such that said drive element is not rotated when said push bar moves from the intermediate extended position to the fully extended position.

31. An emergency release assembly according to claim 24 wherein said push bar is biased toward the fully extended position.

32. An emergency release assembly according to claim 24 wherein said release mechanism includes a base member adapted to be releasaby supported in said muntin, said link member interconnecting said base member and said control member.

33. An emergency release assembly according to claim 32 wherein said link member is defined by a scissors unit formed by at least first and second legs pivotally interconnected to one another, said first leg having a proximal end pivotally secured to said control member by a first axle pin with a distal end opposite said proximal end and said second leg having a proximal end pivotally secured to said base member by a second axle pin with a distal end thereof secured to a medial portion of said first leg.

34. An emergency release assembly according to claim 33 wherein said catch member is defined by a lever pivotally secured to said base member by said second axle pin, said lever including an arm portion that abuts said first axle pin when in the retain state, said lever being pivotable so that said arm portion is pivoted out of the retain state whereby said push bar may move from the intermediate extended position to the fully extended position.

35. An emergency release assembly according to claim 34 wherein said push bar has access opening whereby said lever may be manually pivoted out of the retain state.

36. A sliding door supported for sliding motion in a doorway when said sliding door is in a normally closed configuration yet which is movable in an emergency condition between the normally closed configuration to an emergency open configuration, comprising:
(A) a framework including a muntin that has a recess and peripheral frame portions that define a substantially planar outer muntin face;
(B) a latch mechanism disposed in said framework and operative in a first state to retain the sliding door in the normally closed position and actuable to a second state that allows the sliding door to be moved to the emergency open configuration; and
(C) a release mechanism disposed in the muntin recess and operative to advance the latch mechanism from the first state to the second state, said release mechanism including
(1) a control member coupled to said latch mechanism and supported for reciprocal sliding movement;
(2) a push bar having an outer surface;
(3) at least one link member interconnecting said push bar and said control member such that said push bar may be moved between a fully extended position and a depressed position through an intermediate extended position, said push bar when moved from the intermediate extended position to the depressed position being operative to move said reciprocating member such that said latch mechanism is advanced from the first state to the second state, said push bar when in the intermediate extended position being located entirely within the recess and when in the fully extended position protruding out of the recess; and
(4) a catch member operative in a retain state to limit movement of said push bar between the intermediate extended position and the depressed position yet releasable to an access state wherein said push bar can move from the intermediate extended position to the fully extended position.

37. An emergency release assembly according to claim 36 wherein said release mechanism includes a base member adapted to be supported by said door, said link member interconnecting said base member and said reciprocating member.

38. An emergency release assembly according to claim 37 wherein said link member is defined by a scissors unit formed by at least first and second legs pivotally interconnected to one another, said first leg having a proximal end secured to said control member with a distal end opposite said proximal end and said second leg having a proximal end secured to said base member with a distal end thereof secured to a medial portion of said first leg.

39. An emergency release assembly according to claim 38 wherein said first leg is formed by a pair of spaced-apart, substantially parallel first leg sections each having proximal and distal ends and wherein said second leg is formed by a pair of spaced-apart, substantially parallel second leg sections each having proximal and distal ends.

40. An emergency release assembly according to claim 39 wherein said base member has a pair of opposed ears projecting therefrom, the proximal end of each said second leg section pivotally secured to said ears by an axle pin.

41. An emergency release assembly according to claim 40 wherein the proximal end of each said first leg section is pivotally secured to said control member by a first axle pin and the proximal end of each said second leg section is pivotally secured to said base member by a second axle pin with a distal end of each second leg section secured to a medial portion of a respective said first leg section.

42. An emergency release assembly according to claim 41 wherein said catch member is defined by a lever pivotally secured to said base member by said second axle pin, said lever including one arm portion that abuts said first axle pin when in the retain state, said lever being pivotable so that said arm portion is pivoted out of the retain state whereby said push bar may move from the intermediate extended position to the fully extended position.

43. An emergency release assembly according to claim 42 wherein said catch member is U-shaped in configuration including a pair of spaced-apart arm portions joined by a web portion, each arm portion abutting said first axle pin when in the retain state yet pivotable out of the retain state whereby said push bar may move from the intermediate extended position to the fully extended position.

44. An emergency release assembly according to claim 37 wherein said muntin includes a pair of facing channel structures, said base member slideably received in and supported by said channel structures.

45. An emergency release assembly according to claim 36 wherein said latch mechanism includes a reciprocating latch actuator rod, said release mechanism including a rotatable drive element and a crank arm, said crank arm having a first crank arm end secured to said control member and a second crank arm end secured to said drive element whereby reciprocation of said control member acts to reciprocally rotate said drive element, said actuator rod having a first rod end secured to said drive element whereby reciprocal rotation of said drive element acts to reciprocate said actuator rod.

46. An emergency release assembly according to claim 45 wherein said first crank arm end is slideably secured to said control member such that said drive element is not rotated when said push bar moves from the intermediate extended position to the fully extended position.

47. A sliding door system with breakaway capability, comprising:
(A) a fixed panel oriented in a first plane;
(B) a guide structure extending parallel to the fixed panel;
(C) a carriage piece disposed in said guide structure for sliding movement relative to said fixed panel, said carriage piece including a catch element; and
(D) a sliding door secured to said carriage piece, said door
(1) slidably movable with said carriage piece between
(a) a slidable closed position relative to said fixed panel and
(b) a slidable open position relative to said fixed panel, and
(2) pivotally mounted with respect to said carriage piece at a location spaced from said catch element to be pivotally movably between
(a) a normally closed configuration relative to said carriage piece and said fixed panel and
(b) an emergency open configuration relative to said carriage piece and said fixed panel,
(3) said door including
(a) a frame extending around a perimeter portion of said door and a muntin that has a recess and peripheral muntin sections that have defining surfaces a substantially planar outer muntin face oriented in closely-spaced facing relationship with said fixed panel when in the slideable open position,
(b) a latch mechanism disposed in said frame and operative in a first state to engage said catch thereby to retain said door in the pivotally closed state and in a second state to release said catch thereby to permit said door to pivot from the pivotally closed state to the pivotally open state, and
(c) a release mechanism disposed in the muntin recess and mechanically coupled to said latching mechanism and actuable to advance said latching mechanism from the first state to the second state, said release mechanism including
(i) a control member disposed in the recess and movable within the recess to selectively actuate said release mechanism,
(ii) a push bar having an outer surface,
(iii) at least one link member interconnecting said push bar and said control member such that said push bar may be moved between a fully extended position and a depressed position through an intermediate extended position, said push bar when moved from the intermediate extended position to the depressed position being operative to move said control member such that said latch mechanism is advanced from the first state to the second state, said push bar when in the intermediate extended position being located entirely within the recess and within a geometric projection of the planar outer mount in face and when in the fully extended position protruding out of the recess; and
(iv) a catch member operative in a retain state to limit movement of said push bar between the intermediate extended position and the depressed position yet releasable to an access state wherein said push bar can move from the intermediate extended position to the fully extended position.
